(19) United States
(12) Patent Application Publication
(10) Pub. No.: US 2014/0330689 A1
(43) Pub. Date: Nov. 6, 2014

(54) System and Method for Verifying Online Banking Account Identity Using Real-Time Communication and Digital Certificate

(71) Applicant: Angel Hoi Ling Wong, Hong Kong (HK)

(72) Inventor: Angel Hoi Ling Wong, Hong Kong (HK)

(21) Appl. No.: 13/875,281

(22) Filed: May 2, 2013

(51) Int. Cl. G06Q 40/00

(52) U.S. Cl. CPC G06Q 40/02
USPC 705/35

(57) ABSTRACT

A system and method for verifying online banking account identity using real-time communication and digital certificate, comprising: online banking server with users' bank accounts, security server, users' cellular phones, and digital certificate, wherein the security server is equipped with a server end for real-time communication technology and the user's cellular phone is equipped with real-time communication application, with which the cellular phone uses to connect with the security server. Whenever the user performs online banking services that require identity authentication, the online banking server verifies the user's digital certificate, and performs security authentication through the security server and the user's cellular phone. This increases the difficulty for hackers to commit online banking fraud by infecting a user's Internet terminal with the Trojan Horse virus, because these hackers would still need access to the user's cellular phone to successfully complete the security authentication process and access online banking services.

### TECHNICAL FIELD

The present invention relates to a financial payment technique, in particular to a system and method for verifying online banking account identity using real-time communication and digital certificate.

### BACKGROUND ART

The introduction of online banking services made it possible for bank customers to skip long queues at bank counters and conveniently perform various banking services by logging onto the online banking server via the Internet. However, the increasingly widespread Trojan Horse virus has posed a great threat to online banking security, as hackers strive to infect every possible computer with the Trojan virus and gain impermissible access to sensitive and valuable information. In this case, if a bank customer accesses the online banking server with a computer that is infected with the Trojan virus, a hacker could easily steal the customer's bank account information, including password, and conduct fraudulent transactions. In the presence of the Trojan virus, even the use of digital certificates may fail to strengthen online banking security. With complete unauthorized access to the bank customer's computer that had been infected with the Trojan virus, not only can the hacker steal bank account information, the hacker can also modify the information displayed on the customer's monitor. In this case, when the bank customer transfers funds in online banking, the hacker could take advantage of the digital certificate that the customer had activated during the online banking session to secretly conduct fraudulent transactions in the background, allowing the transfer of finds from the bank customer's account to the hacker's account. At this point, the bank customer might still be unaware that his/her bank account has been compromised by the hacker, given that the Trojan virus can modify the funds transfer confirmation to conceal the real transactional information, which would have revealed the fraud to the customer. In this case, the bank customer would generally discover the fraud upon the receipt of his/her monthly bank statement. Overall, bank customers face the risk of not being compensated for such online bank fraud, as there is a time lag between the occurrence and discovery of the fraud, and more importantly, banks could argue that the Trojan infection resulted from outdated antivirus protection and personal negligence. As such, online banking frauds remain a significant issue to be solved.

### SUMMARY OF THE INVENTION

The purpose of the present invention is to provide a system and method for verifying online banking account identity using real-time communication and digital certificate. Implementation of the present invention will strengthen and ensure the security of online banking services.

The purpose of the present invention is realized through a system for verifying online banking account identity using real-time communication and digital certificate, comprising: online banking server (1) with users' bank accounts, security server (2), users' cellular phones (3), and digital certificate, wherein the online banking server (1) and security server (2) are connected through telecommunication networks; the security server ( )is equipped with a server end for real-time communication technology; the user's cellular phone (3) is equipped with real-time communication application, with which the cellular phone (3) uses to connect with the security server (2) via cellular network, Wi-Fi network, and other wireless networks; the user's bank account is linked to the user's cellular phone (3) and respective digital certificate, which is used to verify the user's identity; also, when the user logs onto the online banking server (1) using an Internet terminal (5) via the Internet (4) to perform online banking services that require identity authentication, the user uses his/her digital certificate to allow the online banking server (1) to verify the user's identity, in which case if the user's digital certificate is successfully authenticated by the online banking server (1), then the online banking server (1) performs another security authentication on the user's identity through the security server (2) and the respective cellular phone (3) that is associated to the user's bank account. The identity authentication process is completed only if the security authentication is successful. The online banking server (1) would only allow access to online banking services that require identity authentication after the completion of the identity authentication process; otherwise the online banking server (1) would properly decline access to the said online banking services.

In addition, a method for verifying online banking account identity using real-time communication and digital certificate is adopted in the said system, comprising: linking the user's bank account to the user's cellular phone (3) and respective digital certificate; setting up a security server (2), which is equipped with a server end for real-time communication technology; setting up real-time communication application on the user's cellular phone (3), which uses the said application to connect to the security server (2) via cellular network, Wi-Fi network, and other wireless networks; also, when the user logs onto the online banking server (1) using an Internet terminal (5) via the Internet (4) to perform online banking services that require identity authentication, the user uses his/her digital certificate to allow the online banking server (1) to verify the user's identity, in which case if the user's digital certificate is successfully authenticated by the online banking server (1), then the online banking server (1) performs another security authentication on the user's identity through the security server (2) and the respective cellular phone (3) that is associated to the user's bank account. The identity authentication process is completed only if the security authentication is successful. The online banking server (1) would only allow access to online banking services that require identity authentication after the completion of the identity authentication process; otherwise the online banking server (1) would properly decline access to the said online banking services.

As such, the purpose of the present invention is well achieved.

The system and method of the present invention helps strengthen online banking security, given that the identity authentication process is carried out by communication with the user's cellular phone (3) using real-time communication technology when the user performs online banking services. Furthermore, the real-time communication between the security server (2) and the user's cellular phone (3) adopts a communication path independent of that used in the original online banking service to perform the security authentication process. In this case, as long as the user is in possession of his/her cellular phone (3), even if the user's computer is infected with the Trojan virus, hackers would still fail to steal funds through the user's online banking sessions, which ultimately ensures the safety of online banking.

### BRIEF DESCRIPTION OF DRAWINGS

FIG. 1 is a schematic drawing of the system for verifying online banking account identity using real-time communication and digital certificate of the present invention;

The FIGURE is exemplary and used for the purpose of illustrating the construction and main features of the present invention.

### DESCRIPTION OF EMBODIMENTS

The method of the present invention will be described below in further detail with reference to the drawings.

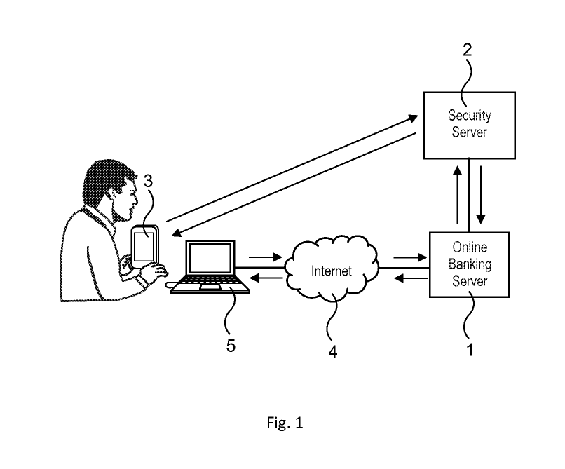

Referring to FIG. 1, a schematic drawing of the system for verifying online banking account identity using real-time communication and digital certificate of the present invention, the system shown in FIG. 1 comprises: online banking server (1) with users' bank accounts, security server (2), users' cellular phones (3), and digital certificate, wherein the online banking server (1) and security server (2) are connected through telecommunication networks; the security server (2) is equipped with a server end for real-time communication technology; the user's cellular phone (3) is equipped with real-time communication application, with which the cellular phone (3) uses to connect with the security server (2) via cellular network, Wi-Fi network, and other wireless networks; the user's bank account is linked to the user's cellular phone (3) and respective digital certificate, which is used to verify the user's identity; also, when the user logs onto the online banking server (1) using an Internet terminal (5), such as a computer or tablet with Internet access, via Internet to perform online banking services that require identity authentication, the user uses his/her digital. certificate to allow the online banking server (1) to verify the user's identity, in which case if the user's digital certificate is successfully authenticated by the online banking server (1), then the online banking server (1) performs another security authentication. on the user's identity through the security server (2) and the respective cellular phone (3) that is associated to the user's bank account. The identity authentication process is completed only if the security authentication is successful. The online banking server (1) would only allow access to online banking services that require identity authentication after the completion of the identity authentication process; otherwise the online banking server (1) would properly decline access to the said online banking services. In the present invention, the security server (2) is added to currently existing online banking systems, and the security authentication procedure, which is carried out by real-time communication between the security server (2) and the user's cellular phone (3), is required to verify user identity during the user's online banking sessions. The online banking server (1) would only allow access to online banking services that require identity' authentication after the completion of the identity authentication process.

Again, referring to FIG. 1, the method adopted by the said system shown in FIG. 1 comprises: linking the user's bank account to the user's cellular phone (3) and respective digital certificate; setting up a security server (2), which is equipped with a server end for real-time communication technology; setting up real-time communication application on the user's cellular phone (3), which uses the said application to connect to the security server (2) via cellular network, Wi-Fi network, and other wireless networks; also, when the user logs onto the online banking server (1) using an Internet terminal (5), such as a computer or tablet with Internet access, via the Internet (4) to perform online banking services that require identity authentication, the user uses his/her digital certificate to allow the online banking server (1) to verify the user's identity, in which case if the user's digital certificate is successfully authenticated by the online banking server (1), then the online banking server (1) performs another security authentication on the user's identity through the security server (2) and the respective cellular phone (3) that is associated to the user's bank account. The identity authentication process is completed only if the security authentication is successful. The online banking server (1) would only allow access to online banking services that require identity authentication after the completion of the identity authentication process; otherwise the online banking server (1) would properly decline access to the said online banking services.

In the above description, the said cellular phone (3) refers to any apparatus that is capable of performing communication, such as smartphones, tablet computers, personal digital assistants, and all other electronic devices that can perform wireless communication through networks, all of which are referred to as cellular phone (3).

The primary characteristic of the present invention is that the security server (2) is able to perform identity authentication using real-time communication between the security server (2) and the user's cellular phone (3), in the process of which the said security server (2) can assign and perform different levels of security verification in accordance to the risk level and payment amount of the transaction. The different levels of security verification are described in further detail below.

Small-amount transactions can allow for relatively simpler security verification, such as whether the cellular phone (3) that is being verified by the security server (2) has successfully connected to the said security server (2), in which case if the cellular phone (3) is successful, then the security verification is completed; otherwise, the security verification would fail. The user can conduct small-amount transactions, as long as the user's cellular phone (3) is in power-on mode and has successfully connected into the security server (2). Furthermore, the security verification can be performed by means of a reminder message, which contains transactional information and is sent upon the completion of online banking transaction to the user's cellular phone (3) through the security server (2), in which case if the reminder message is successfully sent to the user's cellular phone (3), then the security verification is completed; otherwise, the security verification would fail. The security verification is considered completed when the user's cellular phone (3) receives the reminder message, Which informs the user of an online banking transaction of the user's online banking account. In the case that the user receives a reminder message without having undergone any online banking transaction, the user can immediately report the possible online bank fraud to the bank or police authorities to minimize any loss incurred.

Besides of the relatively simpler security verification mentioned above, larger transaction amounts can utilize a higher level security authentication, which requires the user to pre-set a message used for confirmation in the security server (2), which can be a password or a dynamic message. Under this higher level security authentication, when the user performs online transactions with his/her online banking account, the security server (2) will first send a reminder message related to the transaction to the user's cellular phone (3), then the security server (2) will verify the confirmation message sent back from the, user's cellular phone (3), in which case f the security server (2) receives a correct and valid confirmation message, the security verification is completed; otherwise, the security verification would fail. Therefore, in the case that the user's Internet terminal (5) is infected with the Trojan virus, and that the hackers have managed to use the Trojan virus to intercept and modify transactional information transmitted to the online banking server (1), these hackers would still lack the user's cellular phone (3) and the correct confirmation message to successfully perform large-amount transactions, which greatly enhances the security of online banking.

Transactions of relatively larger amounts or higher risks can also utilize a more sophisticated security verification procedure, which is to request users to answer some personal questions to verity the user's identity. To perform this security verification process, the said security server (2) needs to store the user's personal information, such as the user's full name, age, address, contact number, hobbies, occupation, company name and address, history of recent banking transactions, as well as other personal information of the user's family and close relatives. As such, during the security verification process, the security server (2) can generate a message consisting of one or multiple verifying question(s) based on random selection of any stored personal information of the user, then transmit these verifying question(s) to the user s cellular phone (3) and requests the user to respond with a message containing respective answer(s) to the verifying question(s) and send such message to the security server (2) in a specified timeframe (e.g. within 15 seconds) from the user's receipt time of the verifying question(s). The security server (2) will then process the user's response and verify the answer(s) received against the stored information of the user, in which case if all verifying question(s) are successfully authenticated, the security verification is successful; otherwise, the security verification would fail. For example, these personal verifying questions can be “What is the city you were born in,” or “What is the occupation of your spouse,” to which the user has to answer correctly to pass the security verification procedure. In addition, these verifying questions can be presented in the form of multiple-choice, where users are given multiple answers to choose from, making it easier for users to respond quickly to the verifying question(s).

The present invention and method can utilize only one of the different levels of security verification described above, or apply the said verification procedures entirely or partially, and determine the appropriate level of security verification based on the risk level and payment amount. For example, small-amount transactions require simpler verification procedures in connecting the cellular phone (3) to the security server (2); larger-amount transactions require users to respond with a correct confirmation message via the cellular phone (3); online payment transactions, given. the high risk in the nature of online payment, require the user to respond via the user's cellular phone (3) a correct confirmation message and valid answers to multiple verifying questions for the security authentication to be completed. The object of the present invention is well achieved regardless of which of the said security verification level is utilized, hence the use of any one of the said verification level belongs to the protected area of the present invention.

The system and method for verifying online banking account identity using real-time communication and digital certificate of the present invention have been described above in detail; although the present invention is described using the above-mentioned embodiments, the present invention is not limited to the embodiments described, hence various changes and variations can be made without departing from the present invention and the scope of the appended claims.

The system and method for verifying online banking account identity using real-time communication and digital certificate described in the present invention can greatly strengthen the security of online banking. The implementation of the present invention will be beneficial to both banks and bank customers.

1. A system for verifying online banking account identity using real-time communication and digital certificate, comprising: online banking server (1) with users' bank accounts, security server (2), users' cellular phones (3), and digital certificate, wherein the online banking server (1) and security server (2) are connected through telecommunication networks; the security server (2) is equipped with a server end for real-time communication technology; the user's cellular phone (3) is equipped with real-time communication application, with which the cellular phone (3) uses to connect with the security server (2); the user's bank account is linked to the user's cellular phone (3) and respective digital certificate, which is used to verify the user's identity; also, when the user logs onto the online banking server (1) to perform online banking services that require identity authentication, the user utilizes the user's digital certificate to allow the online banking server (1) to verify the user's identity, in which case if the online banking server (1) successfully authenticates the user's digital certificate, and successfully performs the security authentication process on the user's identity through the security server (2) and the respective cellular phone (3) that is associated to the user's bank account, then the identity authentication is considered complete, allowing the online banking server (1) to carry out the respective online banking transactions as requested by the user; otherwise, the online banking server (1) would properly decline access to the said online banking services.

2. A method for verifying online banking account identity using real-time communication and digital certificate, comprising: linking the user's bank account to the user's cellular phone (3) and respective digital certificate; setting up a security server (2), which is equipped with a server end for real-time communication technology; setting up real-time communication application on the user's cellular phone (3), which uses the said application to connect to the security server (2); also, when the user logs onto the online banking server (1) to perform online banking services that require identity authentication, the user utilizes the user's digital certificate to allow the online banking server (1) to verify the user's identity, in which case if the online banking server (1) successfully authenticates the user's digital certificate, and successfully performs the security authentication process on the user's identity through the security server (2) and the respective cellular phone (3) that is associated to the user's bank account, then the identity authentication is considered complete, allowing the online banking server (1) to carry out the respective online banking transactions as requested by the ser; otherwise, the online banking server (1) would properly decline access to the said online banking services.

3. The method for verifying online banking account identity using real-time communication and digital certificate according to claim 2, wherein the said security verification includes the transmission of reminder message containing transactional information from the security server (2) to the user's cellular phone (3), in which case if the reminder message is successfully sent to the user's cellular phone (3), the security verification is completed; otherwise, the security verification would fail.

4. The method for verifying online banking account identity using real-time communication and digital certificate according to claim 2, wherein the said security verification includes the security server (2) verifying the confirmation message sent from the user's cellular phone (3), in which case if the security server (2) receives a correct and valid confirmation message, the security verification is completed; otherwise, the security verification would fail.

5. The method for verifying online banking account identity using real-time communication and digital certificate according to claim 2, wherein the said security server (2) stores users' personal information, and when the security server (2) performs security verification, the security server (2) randomly selects any of the stored personal information to generate verifying question(s), which will then be sent to the respective user's cellular phone (3), and the user has to respond with a message containing answer(s) to the verifying question(s) in a specified timeframe, and the security server (2) will then process the user's response and verify the answer(s) received, in which case if all verifying question(s) are successfully authenticated, the security verification is successful; otherwise, the security verification would fail.
